(19) United States
(12) Patent Application Publication
(10) Pub. No.: US 2024/0059383 A1
(43) Pub. Date: Feb. 22, 2024

(54) INTEGRATED SYSTEM FOR REMOVING AND TREATING MARINE BIOFOULING ON SUBMERGED METAL SURFACES

(71) Applicants: PETRÓLEO BRASILEIRO S.A. – PETROBRAS, Rio de Janeiro (BR); SERVIÇO NACIONAL DE APRENDIZAGEM INDUSTRIAL - DEPARTAMENTO REGIONAL DA BAHIA-SENAI/DR/BA, Salvador (BR)

(72) Inventors: Marcelo Luiz LIGEIRO BARBOSA, Rio de Janeiro (BR); Edisiene DE SOUZA CORREIA, Salvador (BR); Lucas SARMENTO NEVES DA ROCHA, Salvador (BR); Edna DOS SANTOS ALMEIDA, Salvador (BR); Mateus DOS SANTOS DE MENESES, Salvador (BR); Carlos Eduardo DA SILVA JORGE, Salvador (BR); Frederico GARCIA DE OLIVEIRA, Salvador (BR); Luis Carlos MORENO LEDEZMA, Salvador (BR); Alexandro QUIRINO DA SILVA, Salvador (BR); Joaquim RANYERE SANTANA DE OLIVEIRA, Salvador (BR)

(21) Appl. No.: 18/259,643

(22) PCT Filed: Dec. 20, 2021
(86) PCT No.: PCT/BR2021/050568

§ 371 Date: Jun. 28, 2023

(30) Foreign Application Priority Data
Dec. 30, 2020 (BR) 10 2020 026998 4

(51) Int. Cl. B63B 59/08; B63G 8/00; B63G 8/39; B25J 9/16

(52) U.S. Cl. CPC B63B 59/08; B63G 8/001; B63G 8/39; B25J 9/1694; B63G 2008/002

(57) ABSTRACT

The present invention was designed as a technological package capable of implementing the removal of up to 30 cm of biofouling, normally originating from sun coral, on support vessels of ships and oil platforms, without the need for help from divers. The integration of the solution consists of a robotic platform containing a robot for flat areas and a robot for recessed areas, which sends the waste originating from the removal, capturing and crushing to a modular waste-treatment system (MSET). The operations center enables the functioning of all of the integrated systems, being housed in a support vessel, which also has a system for automatically launching and recovering the robot, the control of the robotic platform containing a software architecture capable of allowing the operator to view, plan and record the missions.

### FIELD OF THE INVENTION

The present invention is a system designed to operate in an integrated manner through a tele-operated robotic platform for the removal and treatment in loco of marine bio-scaling containing sun coral, on hulls of submerged metallic surfaces of floating units, with subsequent treatment of the effluent according to the emanated load.

### DESCRIPTION OF THE STATE OF THE ART

Marine bio-scaling occurs on FPSO hulls, semi-submersible platforms, support/service vessels and similar ship hulls, and may be up to 30 centimeters thick. This thick layer increases resistance to slipping in water and, consequently, fuel consumption, as well as causing corrosion on the surface, in addition to increasing the weight of the vessel.

Due to the development of bio-scaling on vessels, platforms and floating structures in general, these bulkheads are one of the main vectors of dispersion and introduction of exotic species in the marine environment. The aim is to contain and control the population of these proliferative species due to the potential impacts on native species, which may reduce or affect the biodiversity of the Brazilian coast.

One of the main invaders of Brazilian biodiversity is sun coral, from the Pacific Ocean, known since the 80s, for having invaded the rocky shores of the coast. Some studies have proven that sun coral is an efficient invader with rapid growth. The sun coral modifies the invaded environment, creating a favorable environment for its permanence, and for that it produces harmful chemical substances which excludes some actors of the native fauna and flora. The sun coral was also observed killing native coral species, some even endemic to Brazil, competing with species of economic value, such as the mussel, affecting primary and coastal productivity (fisheries and sea resources), thus harming a source of food.

National laws require the identification, monitoring and elimination of non-native organisms that have settled in natural areas of biological importance. The aim is to eliminate these proliferative species due to the impacts on native species, which may reduce or affect the biodiversity of the Brazilian coast. This motivation created the need of designing a robot that helps in the identification, removal and collection of vectors that use the hull of vessels to spread around the world, compromising in this case the marine habitat of the country.

Scales interfere negatively as they bring an additional load to a project that possibly did not take into account such excess weight, bringing structural and/or stability (buoyancy) problems.

Scaled ships suffer from increased drag (greater friction with water), and have their displacement speed reduced, increasing fuel consumption.

The hulls range from flat geometries with large radius of curvature to more complex geometries with niche areas, for example: riser counters, hull protection structures, structural reinforcements, areas of difficult access, etc.

Commonly, the removal of bio-scaling both on the hull and in difficult places is carried out by divers equipped with appropriate tools and the removed material may not be completely collected, but rather left in the environment. The operation presents risks for the operator due to the large extension and irregularities of the surface, as well as for the environment, since invasive species and fragments of surface paint containing heavy metals or other harmful substances spread in the environment, disrupting the balance of that subsystem.

The development of technologies that do not require human diving is essential to provide safer operations. In this context, the design of a robotic system for the removal of bio-scaling presents itself as an excellent alternative for reducing costs and human exposure to this type of operation. Likewise, it is important that the system is coupled to an effluent treatment module containing bio-scaling, which guarantees the proper disposal of solid waste generated and return of liquid effluent to the sea (free of living organisms), preventing the proliferation of exotic species. With the development of technologies, it is currently possible to replace human labor in this activity, thus providing a more efficient and safer operation.

The system claimed in document U.S. Pat. No. 7,905,192B 1 comprises an integrated cleaning and treatment system comprising a vehicle consisting of a compartment equipped with brushes for removing bio-scaling and a compartment for separating solids from bio-scaling, and these solids are pumped to a treatment by means of a flexible hose. This vehicle needs to be driven by an operator, the mechanical strength of the brush bristles is considered low due to its slenderness index, which limits the removal in the calcium carbonate-based organism; in addition to this factor, there is the capture that is linked to a pump without the intermediary of a crusher, which causes a low solid/liquid flow or a total blockage of the system.

Document JP2008018745A refers to an underwater cleaning robot to remove organisms such as blue mussels and red barnacles growing on a submerged surface.

Document WO2019028562A1 discloses a self-propelled machine guided by an operator for removing bio-scaling. The application for invention does not show the structure used for integration and operation of the self-propelled machine.

Document U.S. Pat. No. 4,890,567A discloses a robot-operated device that uses an ultrasonic transducer for cleaning ship hulls. The device can also be used to spray paint or other chemicals on the sides of ship hulls.

Document U.S. Pat. No. 9,038,557B2 discloses a robot for operation on a surface on a ship hull. The robot may include a drive subsystem onboard the robot for steering and maneuvering the robot around the hull. It has a sensor subsystem that can detect a robot attachment state to the hull. The attachment state can include at least one of either a coupled or an uncoupled state. A signal generation subsystem on board the robot can issue a distress signal when the robot attachment state is decoupling, or in other words, when the robot disconnects from the hull. The system for detecting the detachment of the robot from the hull includes a processor, a memory for storing hull property data.

Document EP2285503B1 discloses a method for cleaning and suctioning polluting materials that can be found on underwater surfaces such as ship hulls, platforms, concrete constructions, tanks, port constructions and other types of constructions that are under water and the like. It is an objective to be able to suck up dirty material that is sprayed loose from surfaces so that it is not released into the body of free water, in addition to the sucked-up fluid being treated with UV radiation so that micro-organisms are killed and the water can be left back to the sea.

Robots for marine bio-scaling removal are described in some patent documents, U.S. Pat. Nos. 4,890,567A, 9,440,717B2, US20140116316A1 and U.S. Pat. No. 9,663,201B2. The company SEAROBOTICS CORP filed a family of patents referring to a robot for cleaning bio-scaling on submerged surfaces, US20120006352A1, US20130298817, US20130298817A1, US20140230711 and US20140230711A1.

The company RAYTHEON CO also filed a family of robot patents for cleaning bio-scaling, with emphasis on U.S. Pat. No. 9,180,934B2 (autonomous handling and cleaning system) and the above-mentioned U.S. Pat. No. 9,038,557B2.

With the development of technologies, it is currently possible to replace human labor in this activity, thus providing a more efficient and safer operation that presents a certain robustness.

None of the highlighted applications presented a methodology for integration and control of the systems according to the present invention. Even submerged cleaning robots, as presented by US20140116316A1, due to their architecture, are not able to remove the type of bio-scaling presented here, and therefore do not have subsystems that can be adapted. There is also no application capable of describing the integration of all systems, even the most recent ones do not have enough information to solve the presented technical problem. Systems that treat bio-scaling, such as EP2285503B1, the transport of the bio-scale removed and captured by the robot to a support vessel, where a filter separates the solid part from the liquid part that is inertized by UV radiation and returned to the sea. This functionality, however, is only suitable for micro-scaling (bio-scaling), not suitable for macro-scaling.

The objective of the integrated system of the present invention is to achieve an efficiency in the removal and capture of macro-scaling greater than 99.5%. This efficiency should be achieved through the combination of a robotic platform adaptable to flat, concave or convex surfaces, an efficient removal and capture system that avoids dispersion of fragments on the seabed, a crushing system designed to operate with low head loss and greater flow rate compared to others in the state of the art, equipped with a simultaneous clearing system, wherein larger fragments are retained and returned to the crusher.

The present invention can be fully applied to meet environmental restrictions and good international practices, which involves the removal of marine bio-scaling containing sun coral from the hulls of floating units (FPSO, SS, NS and service/support vessels and hulls similar) and that bring tools with functionalities not presented in the state of the art.

### SUMMARY OF THE INVENTION

The present invention consists of an integrated control system which allows an operator to remotely guide a robotic platform and let an effluent treatment system work asynchronously. The robotic platform acts submerged on flat steel alloy surfaces containing bio-scales of up to 30 cm.

The control system receives positioning and instantaneous location information from the robotic platform for automatic and manual actions, which may be through visual information from perception and mapping subsystems installed in the robotic system.

The support vessel has a launch system mainly containing a garage for the robotic platform. The launch subsystem is all related to the logistics of launching the robot into the water. This subsystem is intrinsically linked to the operation of the robot together with the MSET, in addition to being complementary to the safety subsystem.

The integrated system allows the controller to only remotely operate the robotic platform through cameras and sensors, eliminating any need for human diving, in any steps of the removal, containment and capture processes of marine bio-scaling removed from the hull and during the shipment of the effluent to be treated in the support vessel. Linked to this, there is a safety subsystem that is responsible for providing workaround strategies for any problems that may occur during the operation of the robotic platform.

The general architecture presents the software components and communication protocols with the other components of the system. In this way, it helps in modeling a software architecture capable of satisfying the main requirements of the project, such as: performance, reliability, portability, maintainability, interoperability, among others.

### DESCRIPTION OF DRAWINGS

The present invention will be described in more detail below, with reference to the attached figures which, in a schematic and non-limiting way of the inventive scope, represent examples of embodiments thereof. In the drawings, there are:

FIG. 1 illustrating a view of the parts of the integrated system, where the robotic platform acts on the target vessel and is operated by an operations center on the support vessel.

FIG. 2 illustrating the concept of the robotic platform where the robot for flat areas is connected to the robot for niche areas.

FIG. 3 illustrating the robot for niche areas and its parts.

FIG. 4 showing an overview of the system.

FIG. 5 showing the subdivisions regarding the vision of the electrical and communication architecture of the robotic platform together with the integrated control system.

FIG. 6 illustrating the automation architecture of all systems.

FIG. 7 illustrating the launch system components.

### DETAILED DESCRIPTION OF THE INVENTION

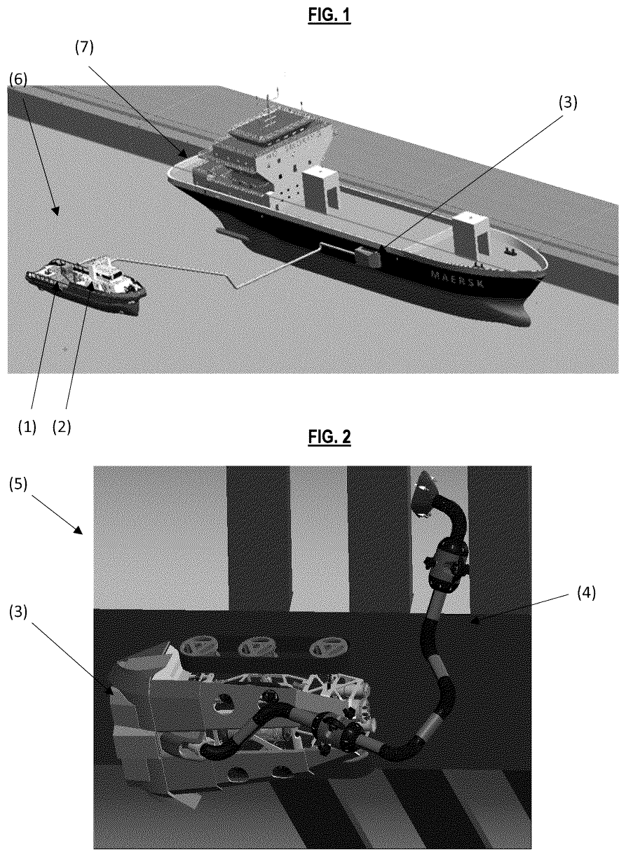

The present invention discloses how the robotic platform (5), the robot for removal of flat areas (3) and the robot for niche areas (4), and the MSET (1) were divided into functional sectors, strongly based on the design view where electrical power distribution and data communication signals prevail. The support vessel (6) contains the entire operation center (2), the robotic platform garage, the launch system and the space for installing a modular system for effluent treatment (MSET) (1), as illustrated in FIG. 1.

The robotic platform (5), FIG. 2, has a robot for flat areas (3) that operates submerged and has a series of sensors and actuators being designed to be teleoperated from the support vessel. Coupled to it, there is a robot for niche areas (4), whose robot body consists of rigid links (10) connected by flexible joints (11), allowing greater adaptability to the structure.

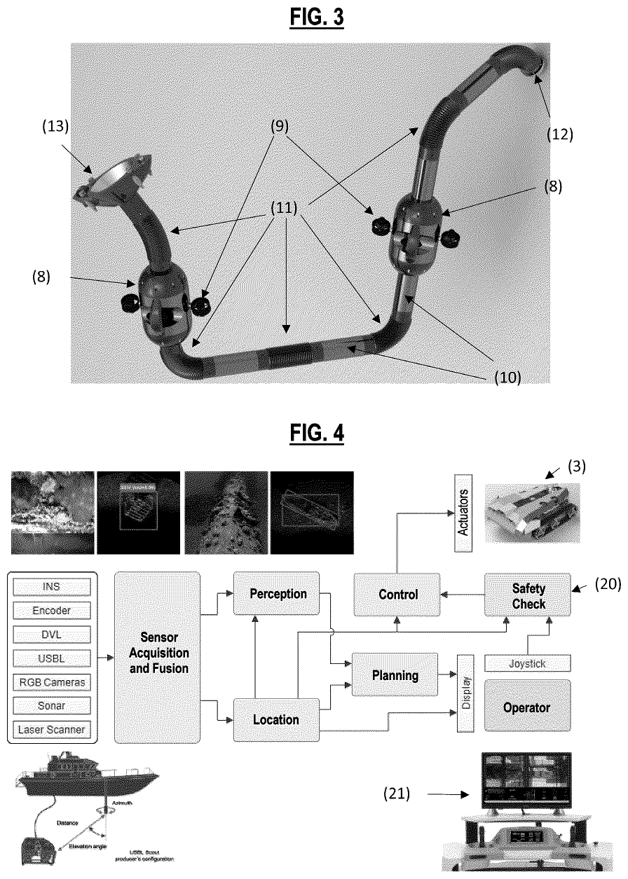

The robot for niche areas (4) has flexible joints that are actuated, allowing the positioning control of each one of them and allowing the entry into confined environments of a vessel. In FIG. 3, which represents the robot for niche areas (4), it can be seen that in its structure there are two “balloons” (8) with thrusters (9). These modules are intended to control the stability of the body of the robot for niche areas, as it was a worrying factor for the concept, since if there were no balloon modules (8) with thrusters (9), the only point of support for the robot would be at the point of connection with the robot for flat areas. The connection point (12) is for connecting with the upper part of the robot for flat areas (3) and the engagement point (13) is intended for coupling with auxiliary cleaning tools, according to the type of work to be accomplished.

The cleaning process may take several days to be carried out, which would imply the need to reposition the robotic platform (5) on the hull daily from the stopping point of the previous day, as well as the ability to inform the operator which region of the hull has already been cleaned and which region still remains to remove the scale. All these aspects make the operation of this platform complex and demand the existence of a system capable of assisting the operator and facilitating the process of navigation, approach and removal of bio-scaling.

The robotic platform (5) is placed in the water from a launch system (40) as shown in FIG. 7. This system will consist of a crane (43), an umbilical controller system (44) and a garage (42) for the robotic platform (5). This system aims at reducing the risks linked to the robot operation, since this operation presents high collective risks for operators. The crane (43) of this system is adapted for operation with robotic platforms (5), thus enabling the control of the umbilical and all conduits that are in connection between the robot and the auxiliary system arranged on the support vessel. The garage (42) for the robotic platform (5) is a strategic piece of equipment as it will allow the robot to return to the launch system (40) when necessary. In the garage (42) there will be some fiducial landmarks (41), which will make it possible, through computer vision, to identify the pose of the robot in relation to the pose of the garage. With this information, the robotic platform (5) can automatically line up and enter the garage (42) without danger and without the need for an operator. The operation of the garage entrance (42) by the robot is done as follows: The operator positions the robot close to the garage entrance so that the cameras arranged on the front part of the robotic platform (5) enable the identification of the fiducial landmarks (41). After identifying the fiducial landmarks through computer vision, the robotic platform will automatically enter the garage (42) without the help of a human being.

The entire flow resulting from the crushing process and the self-cleaning filter located on the robotic platform (5) are united and the effluent is conducted through the suction pipe connected to a pump located in a pumping unit external to the robotic platform (5) and preferably located on the support vessel (6). This pump is fixed through a lifting system, which can be the crane (43) or a dedicated equivalent, fixed to the support vessel (6), with height adjustment, and dynamic positioning, offering the possibility of adjusting the height between the level of the robot and the external pumping unit, all done dynamically, reducing the space occupied on the robotic platform, and increasing the pumping capacity. The external pump communicates with the MSET via a discharge pipe between the pump outlet and the MSET inlet.

The present invention considers that the actuation control of the robotic platform is done in a teleoperated way, so the software architecture is divided into three parts: an architecture for the operation application, an architecture for the software that controls the robot and one related to the simulation module. With the integration of these three parts, they communicate as if it were a uniformly distributed system.

The implementation of software architectures allowed a division into layers. The presentation layer (human-machine interface) it displays relevant information on a display computing device, and additionally interprets responses from the application layer below it. The main components listed in this layer are: Dashboard, Route and 3D Planning, Cameras and Sonars Viewer, Mission Status and Mission Record.

The Dashboard (61) is responsible for building one or more panels to concentrate the indicators and information from the robot, sensors and some data from the treatment plant. The Route and 3D Planning (62) is the component that holds one or more visualization panels responsible for displaying the three-dimensional map of the vessel being cleaned, indicating the total planned route and for the day activities, which part of the vessel has already been was cleaned and what are the operating limits for the cleaning robot. The Cameras and Sonars Viewer (63) is responsible for building the display panels of cameras and sonars images for the operator, in addition to displaying a 360° image emulating an aerial view composed from the transformation and fusion of a set of cameras attached to the side of the robot. The Mission Status (64) is the component responsible for the panels that show the mission status information, such as: how many hours estimated for the total cleaning of the vessel, how many hours of cleaning have already been carried out, percentage of the completed mission, estimated time for the purpose of cleaning, amount of material sent to the treatment plant and other relevant statistics. The Mission record (65) concentrates the panels responsible for registering and editing the mission, the submission of a mesh file of the vessel to be cleaned and access to data and statistics generated by the cleaning process (3D map of the bio-scaling, 3D map of the vessel clean and other information).

FIG. 4 shows an overview of the system. There, it is possible to observe some sensors, such as INS, Encoder, DVL, USBL, RGB Cameras, Sonars and Laser Scanner, feeding a step of data acquisition and fusion followed by a step of perception and another of location. These steps, in turn, generate information for the planning step responsible for defining the best strategy for carrying out the mission. Such information is provided through a display for the operator to control the robot using a joystick type input device and alphanumeric keyboards.

The commands collected from the joystick pass through a safety controller component (20) that verifies that they do not violate the operating limits according to the current conditions of the robot. Then, they are passed to a control system that operates in closed loop using the current location of the robot, according to the sensors. In turn, the control system is responsible for activating the actuators that move the robot and perform the cleaning process.

The robotic platform (5) contains a series of embedded systems housed in housings, in which there is the main housing (32), the power housing (33), backup housing (34) and the interconnections with the other components (35), placed in a strategic position according to their functionality.

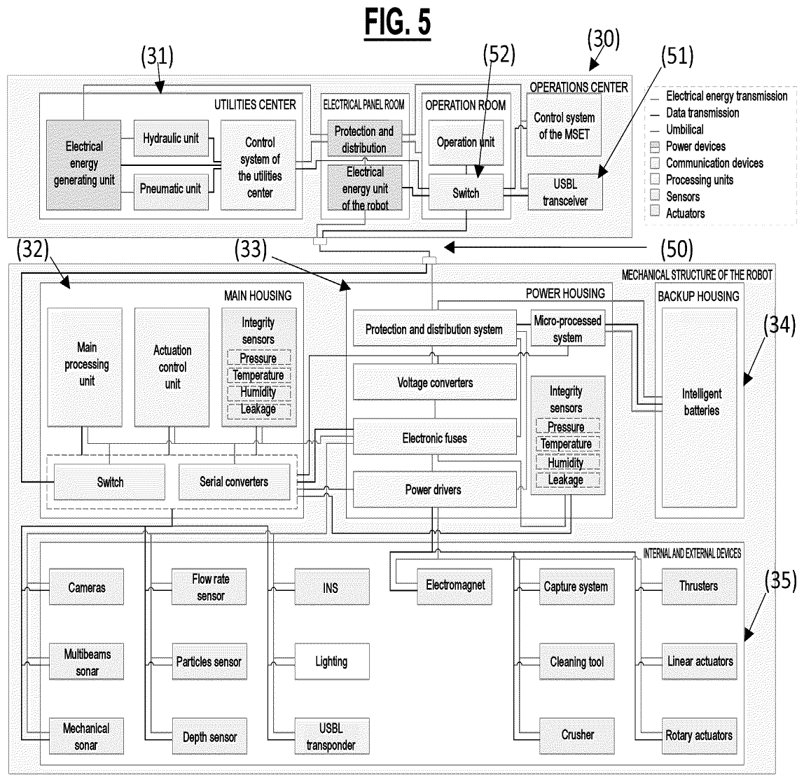

The main housing (32) contains the Ethernet Switch which makes the data communication connection with the operations center (30). Cabling is done through umbilicals (50) and are shown in FIG. 5 and FIG. 7. Together it contains serial signal converters, which receive and send communication signals from a series of devices on the platform, whose standard can be RS232/RS422/RS485 and fiber optics, but not limited to these. It also houses the main processing units of the vehicle and control and actuation unit, as well as basic sensors for device integrity (e.g., temperature, pressure, humidity, etc.).

The power housing (33) of the robotic platform receives the electric energy transmission line. It is the macro system responsible for protecting, managing and distributing electrical energy to the other devices of the robotic platform and contains the electronic devices responsible for the protection, control and conditioning of the electrical energy that will supply the demand of the robot devices and, when possible, will contain the power drivers of actuator elements. It is subdivided into protection and distribution system, voltage converters, electronic fuses and power drivers. The protection and distribution system receives electrical energy through umbilical cables and distributes the demand to voltage converters and intelligent batteries. The energy passes through electronic fuses, which can be sent to the sensor devices and to the power drivers that will feed all the actuator devices.

Both pressure housings (Main and Power) have integrity sensors in common, as shown in FIG. 5. The purpose of these sensors is to monitor the internal environment of the pressure housings, avoiding catastrophic failures. It uses a microcontroller board that contains the communication interface that can be used to collect data from sensors and communicate with the processing units of the robotic platform. These boards will be in charge of providing environmental information on the housings, such as temperature, pressure, humidity and leakage indication values.

Unlike the other pressure housings, as it does not have an interface with the umbilical, there is the Backup Housing (34). Its purpose is to supply electrical energy to the critical devices of the robotic vehicle when there is no feeding coming from the electrical energy unit of the robot platform. Therefore, it contains only intelligent batteries, that is, it has integration with a controller board that provides a communication interface for monitoring variables. The purpose of this pressure housing was to serve as a source of secondary electrical energy that can be used to supply the demand for the robot essential devices in a critical moment. However, the electrical supply to the robotic platform does not require this backup housing.

The robotic platform has a series of internal and external devices (35) installed and distributed throughout the mechanical structure of the robotic platform. For the actuators, namely the electromagnet, capture system, cleaning tool, crusher, thrusters, linear actuators and rotary actuators, the electrical and communication connection will be made directly with Power Housing devices. The other devices, including cameras, sonars, sensors (flow rate, particles and depth), INS, lighting and transponder, in this layer will also be energized by Power Housing elements, however, their communication will be with the devices of the processing units of the Main Housing.

To ensure communication and energizing of the elements that make up the robotic platform (5), an architecture proposal was developed as shown in FIG. 5. The operations center has essential elements to allow communication between the operation unit and the robotic platform, it also has a utilities center (31), the electrical panel, operation room, MSET control system, in addition to using the USBL Acoustic Transceiver of the vessel, and being responsible for providing mechanical energy in pneumatic and hydraulic form. With this, the operations center maps the need to supply utilities, and thus the support vessel has an Electric Energy Generating Unit, a Hydraulic Unit and a Pneumatic Unit. Accordingly, the entire robotic platform and the MSET are unified by systems that are interconnected and controlled by the operations center (30). The operations center (30) is responsible for providing electrical and mechanical power and obtaining information to determine basic actions for the other subsystems.

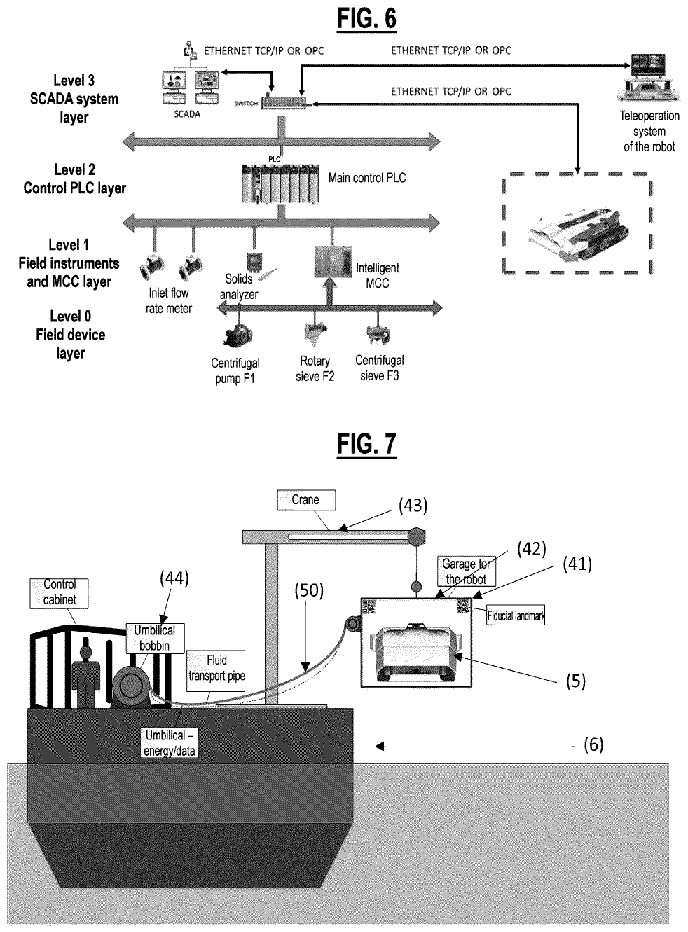

In order to monitor and control the main process variables of the MSET (1), an instrumentation concept based on 4 levels of layers was used (FIG. 6). Such an instrumentation concept correlates all equipment of the MSET (1) with the process variables necessary for the solution to work. Based on the technical requirements of the solution, it was defined that the entire operation and control of the process foreseen for the MSET (1) must be automated, in order to reduce operator intervention in the process and in decision making. In this case, the implementation of a level 3 architecture in the automation pyramid was proposed (FIG. 6). The electrical feed concept of the MSET (1) supplies low voltage (˜3-380/440 Vac) through an intelligent MCC (Motor Control Center). Such a characteristic was conceived due to the possibility of making the integration with the automation system more flexible and also providing a more robust level of electrical safety (protection relays 50/51, 64), in addition to allowing the monitoring of all electrical variables and the status of the various equipment that composes the solution (multimeters with functions: A, V, kW, kWh, kVAr, kVArh, PF, Demand).

The MSET automation concept provides a control system with a large PLC due to its flexibility to meet the most demanding applications and environments, in addition to offering modular architectures and a range of I/O and network options, in which a supervisory system SCADA (Supervisory Control and Data Acquisition) is used.

The automation architecture of the robotic platform (5) (FIG. 6) was integrated with the robot controller in the Main Housing (32) and connected to the Switch (52) of the operating room, through a digital communication protocol, and may preferably be via Ethernet TCP/IP or OPC, but not limited to these. This is necessary because it provides interaction between the two systems and the others that run in parallel and also brings safety interlocking functionality.

The composition of each of the network layers of the automation architecture proposed for the present invention as a whole is shown in FIG. 6, which are: Level 0 (Production Processes) where there are found all the processes and equipment necessary for the carrying out the activities for which the MSET is intended; Level 1 (Field Device) consists of field instruments and intelligent relays of the MCC that perform measurement functions and operating status of each of the equipment that make up Level 0; Level 2 (Individual Control of Plant Activities) is the PLC, responsible for the main automated control of the MSET and integration with other systems (SCADA, Robot, instruments and MCC), and, finally, Level 3 (Process Supervision and Optimization) is intended for supervising and optimizing the industrial processes performed by a determined work cell of the MSET (1). In this sense, it is normal for there to be a database to support the operation with all the information related to the process. It is at this level that the SCADA system is located, which shall be integrated with the control and monitoring system of the robotic platform.

We claim:

1. An integrated system for removal and treatment of marine bio-scaling on submerged metallic surfaces of vessels (3) characterized in that it comprises a robotic platform (5) interconnected by an umbilical (50) to an operation center (2) and to a modular system for effluent treatment MSET (1) located on a support vessel (6), the whole system being integrated where the robotic platform (5) is teleoperated through a computational architecture where the vision and interface with the operator is done via a computer program, wherein the location system of the robotic platform (5) is based on a non-georeferential scheme using sonar sensors and a USBL acoustic transceiver (51) of the support vessel (6).

2. The integrated system according to claim 1, characterized in that the robotic platform (5) has a robot for flat areas (3) and a robot for niche areas (4).

3. The integrated system according to claim 2, characterized in that the robot for niche areas (4) consists of rigid links (10) and flexible joints (11) along the length, and contains at least one balloon in an intermediate position (8), which contains at least one coupled Thruster (9).

4. The integrated system according to claim 2, characterized in that the robot for flat areas (3) has an architecture consisting of three housings, the main housing (32), the power housing (33) and the backup housing (34).

5. The integrated system according to claim 4, characterized in that the main housing (32) comprises a main processing unit, an actuation control unit, a Switch, several digital converters and pressure, temperature, humidity and leakage sensors.

6. The integrated system according to claim 9, characterized in that the power housing (33) has a protection and distribution system connected with voltage converters, electronic fuses and power drivers, and has pressure, temperature, humidity and leakage sensors.

7. The integrated system according to claim 4, characterized in that the Switch of the main housing (32) is connected to the Switch (52) of the operations center (30) via the umbilical (50), wherein it uses standardized communication protocols preferably of the Ethernet TCP/IP or OPC type.

8. The integrated system according to claim 4, characterized in that the transmission of electrical energy is carried out via the connection of the electrical panel of the operations center (2) with the power housing (33) of the robot for flat areas (3) via the umbilical (50).

9. The integrated system according to claim 4, characterized in that the backup housing (34) has intelligent batteries which are charged and microcontrolled by the power housing (33).

10. The integrated system according to claim 4, characterized in that the robot for flat areas (3) has a series of actuators and sensors (35) installed and distributed throughout the mechanical structure, wherein the communication between these devices is made with the signal processing unit located in the main housing (32) and the electrical feed with the power housing (33).

11. The integrated system according to claim 10, characterized in that the actuators are electromagnets, capture systems, cleaning tool, crushers, thrusters, linear and rotary actuators.

12. The integrated system according to claim 10, characterized in that the sensors are cameras, sonars, flow rate sensors, particle sensors, depth sensors, INS, lighting and transponder.

13. The integrated system according to claims 3 and 4, characterized in that the robot for flat areas (3) has a connection point with the connection point (12) of the robot for niche areas (4).

14. The integrated system according to claim 3, characterized in that the robot for niche areas (4) has an engagement point (13) for coupling cleaning tools.

15. The integrated system according to claim 1, characterized in that the support vessel (6) comprises a launching system (40) for the robotic platform (5) containing a crane (43), a garage (42) with fiducial landmarks (41) and an umbilical controller (44).

16. The integrated system according to claim 1, characterized in that the support vessel (6) comprises a lifting system that has a dynamic height and positioning adjustment, reducing the height difference between the robotic platform (5) and the external suction pump.

17. The integrated system according to claim 1, characterized in that the MSET (1) receives the raw effluent from the robotic platform (5) and is controlled by a supervisory system with graphic elements, wherein all process variables from the instrumentation of each equipment of the MSET (1) are correlated with the process data from the robotic platform (5).

18. The integrated system according to claim 1, characterized in that the communication network of all integrated equipment have been separated into layers, where the level layer 0 has the equipment of the MSET (1) and generating units connected, layer 1 contains all the field instruments and sensors, layer 2 contains the control PLCs, and layer 3 contains the supervisory system, the teleoperation software architecture and the communication architecture of the robotic platform (5).

19. The integrated system according to claim 1, characterized in that the support vessel (6) has a utilities center (31) which receives energy from an electric energy generating unit, a hydraulic energy generating unit and a pneumatic energy generating unit, and all units are interconnected with a single control system of the utilities center, wherein it has field instruments and intelligent relays to make up the intelligent MCC.

20. The integrated system according to claim 1, characterized in that the operations center (6) comprises an operation unit (21) containing input devices, wherein it consists of a software architecture divided into layers, where the presentation layer has computational devices with display, and these interpret all the responses of the application layer, wherein the presentation layer consists of: dashboard (61), route and 3D planning (62), viewer of cameras and sonars (63), mission status (64) and mission record (65).

21. The integrated system according to claim 19, characterized in that the input devices of the operating unit has a safety controller computational system (20), which establishes the operating limits of the robotic platform (5), according to the conditions presented by the sensors.
